(19) United States
(12) Patent Application Publication
(10) Pub. No.: US 2018/0105455 A1
(43) Pub. Date: Apr. 19, 2018

(54) SILICA TEST PROBE AND OTHER SUCH DEVICES

(71) Applicant: Corning Incorporated, Corning, NY (US)

(72) Inventors: Daniel Wayne Levesque, JR., Avoca, NY (US); Barada Kanta Nayak, Painted Post, NY (US); Kristopher Allen Wieland, Painted Post, NY (US)

(21) Appl. No.: 15/783,536

(22) Filed: Oct. 13, 2017

Related U.S. Application Data
(60) Provisional application No. 62/409,059, filed on Oct. 17, 2016.

(51) Int. Cl. C03C 15/00; C03B 33/02; B01L 3/00

(52) U.S. Cl. CPC C03C 15/00; C03B 33/0222; B01L 2300/0887; B01L 2300/0896; B01L 3/5027

(57) ABSTRACT

A device includes a sheet of high purity fused silica that has a thickness of less than 500 μm, where the sheet includes features in the sheet, wherein the features have a cross-sectional dimension of less than 50 μm and a depth of at least 100 nm, wherein the features are spaced apart from one another by a distance of less than 50 μm, and wherein the silica is free of indicia of grinding and polishing.

### CROSS-REFERENCE TO RELATED APPLICATIONS

this application claims the benefit of priority of U.S. Provisional Application Ser. No. 62/409,059 filed on Oct. 17, 2016 the contents of which are relied upon and incorporated herein by reference in their entirety as if fully set forth below.

### BACKGROUND

Aspects of this disclosure relate to devices and assemblies formed in silica, such as test probes for printed circuit boards and nano-scale fluidic devices formed in high purity fused silica and methods of making them.

Today, the microprocessor manufacturing industry uses “test probes”—devices that connect up to an individual die and allow electrical probing of the die by sending power or signals to the test probe and measuring output. To illustrate the concept, a basic analogy would be a multi-meter to test voltage of a car battery. The battery is presented to a test probe station. Two probes come down and establish electrical contact with the battery and an electrical signal is measured using the multi-meter. The probes then lift off and the battery is determined to be good or bad and is binned accordingly, or sent for further testing. This same general operation happens on a much smaller scale in the semiconductor industry, and can happen in parallel, with many devices (die) being testing at once.

Traditionally test probes in the semiconductor industry are considered a wear part and are routinely changed to reduce damage caused by the probing. Historically, test probe cards were made with (green) printed circuit boards with large copper electrical traces serving as test probes. These traces would have many different metal bumps (hemispheres) that would make contact with the electrical leads of a mating part. The traces would terminate in a connector that mated to test equipment, such as a LCR (i.e. inductance, capacitance, resistance) meter, frequency analyzer, multi-meter, function generator, etc.

One way faster and faster microprocessors are made is by decreasing the size of the die because speed increases in computing when you reduce the distance electrical signals travel. However, the same electrical connections are present as with a larger die, therefore the electrical connections must accordingly be made smaller and denser. Some conventional test probes and materials may lack sufficient precision. Further, Applicants believe that because die patterns often change, test probes should be either easily configurable or disposable.

### SUMMARY

The present Applicants have endeavored to supply a test probe solution that would enable 25 μm features for a test probe out of high purity fused silica, glass with excellent dielectric properties. Glass is generally electrically isolating and may be used as an isolator of electrical signals, such as signals that operate at 1 Hz to less than 10⁹ Hz. The basic design is an electrical insulator with many electrical traces. Aspects of the present technology may be used to form other devices and structures with glass, such as high purity fused silica.

Aspects of the present technology relate to a device, such as test probe or micro-fluidic device, that includes a sheet of high purity fused silica that has a thickness of less than 500 μm, where the sheet includes features in the sheet, wherein the features have a cross-sectional dimension of less than 50 μm and a depth of at least 100 nm, wherein the features are spaced apart from one another by a distance of less than 50 μm, and wherein the silica is free of indicia of grinding and polishing.

Additional features and advantages are set forth in the Detailed Description that follows, and in part will be readily apparent to those skilled in the art from the description or recognized by practicing the embodiments as described in the written description and claims hereof, as well as the appended drawings. It is to be understood that both the foregoing general description and the following Detailed Description are merely exemplary, and are intended to provide an overview or framework to understand the nature and character of the claims.

### BRIEF DESCRIPTION OF THE FIGURES

The accompanying Figures are included to provide a further understanding, and are incorporated in and constitute a part of this specification. The drawings illustrate one or more embodiments, and together with the Detailed Description serve to explain principles and operations of the various embodiments. As such, the disclosure will become more fully understood from the following Detailed Description, taken in conjunction with the accompanying Figures, in which:

FIG. 1 is schematic diagram of a setup for processing according to an exemplary embodiment.

FIGS. 2a to 2g are Zygo images of holes or indentations formed in fused silica according to an exemplary embodiment.

FIG. 3 is a schematic diagram of steps of a process for making a test probe, according to an exemplary embodiment.

FIGS. 4a to 4c are digital images of a glass substrate with channels at different magnifications, according to an exemplary embodiment.

FIGS. 5a to 5b are digital images of a glass substrate with channels that have been etched, at different magnifications, according to an exemplary embodiment

FIGS. 6a to 6c are digital images of a glass substrate with channels of different spacing therebetween, according to an exemplary embodiment.

### DETAILED DESCRIPTION

Before turning to the following Detailed Description and Figures, which illustrate exemplary embodiments in detail, it should be understood that the present inventive technology is not limited to the details or methodology set forth in the Detailed Description or illustrated in the Figures. For example, as will be understood by those of ordinary skill in the art, features and attributes associated with embodiments shown in one of the Figures or described in the text relating to one of the embodiments may well be applied to other embodiments shown in another of the Figures or described elsewhere in the text.

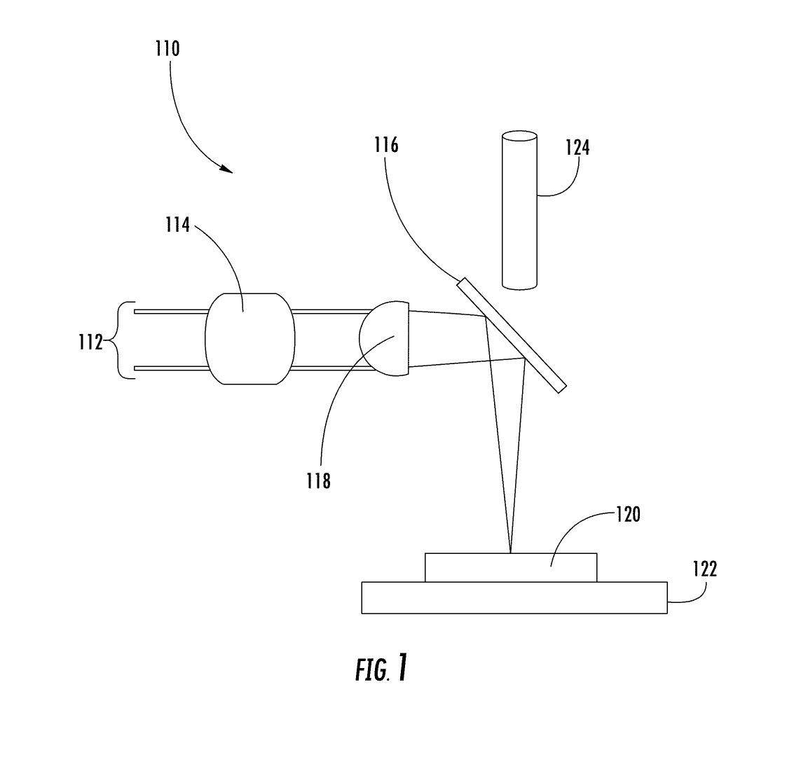

Referring to FIG. 1, a setup 110 includes a laser beam 112 or beams, a variable attenuator 114, a mirror 116, optics 118, a substrate 120, and a stage 122. In some embodiments, the laser beam 112 is pulsed, such as pulsed at a duration of less than a millisecond, such as less than 100 μs, such as about 50 μs, and/or at least 100 ns. In some embodiments, the variable attenuator 114 may be used to reduce pulse energy of the laser beam 112. In some embodiments, prior to the optics 118, the laser beam 112 is round in cross-section and has a diameter of less than 15 mm, such as about 11 mm, and/or at least 5 mm. Angle of incidence of the laser beam 112 from the mirror 116 may be zero and spot diameter of the laser beam 112 at the substrate 120 may be about 150 μm, such as at least 50 μm and/or no more than 300 μm. In some embodiments, the optics 118 include a lens with one surface planar and the other surface convex, such as plano-convex lens with an effective focal length of about 5 inches. In some embodiments, the mirror is a dichroic mirror. According to an exemplary embodiment, fluence of the substrate 120 during the laser processing is about 1.0 to about 5.0 J/cm². In some embodiments, the substrate 120 is or includes glass, such as is or includes silica, such as high purity fused silica, over 99.99% by weight silica. In other embodiments, the silica is doped, such as having less than 10% by weight dopants. In some embodiments, the stage 122 is an X-Y stage. In other embodiments, other setups or modifications of the present setup 110 may be used. The process may be observed in situ by a camera 124, which may provide feedback used to control the laser beam 112 and/or the stage 122.

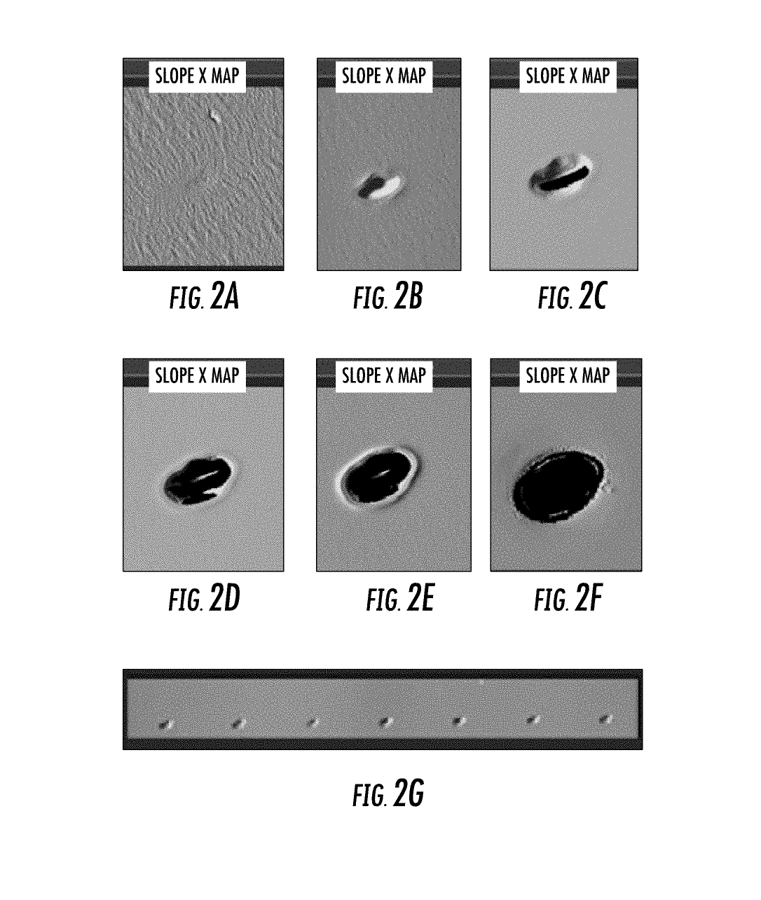

In some embodiments, the laser beam 112 is at a wavelength of about 9.3 μm, and may be from a CO₂ laser source. Conventional laser machining may typically be performed at CO₂ wavelengths of 10.6 μm. However, Applicants believe the 9.3 μm wavelength to facilitate finer features due to close proximity to vibrational frequency of silica. For example, the holes and indentations formed in FIGS. 2a to 2g are on the order of nanometers, such as having a cross-sectional dimension (e.g., diameter, width) of less than 1 μm, such as less than 500 nm, such as less than 200 nm, such as on the order of 10s of nm. Arrays of such features, as shown in FIG. 2a may control flow and/or filter flow of liquids.

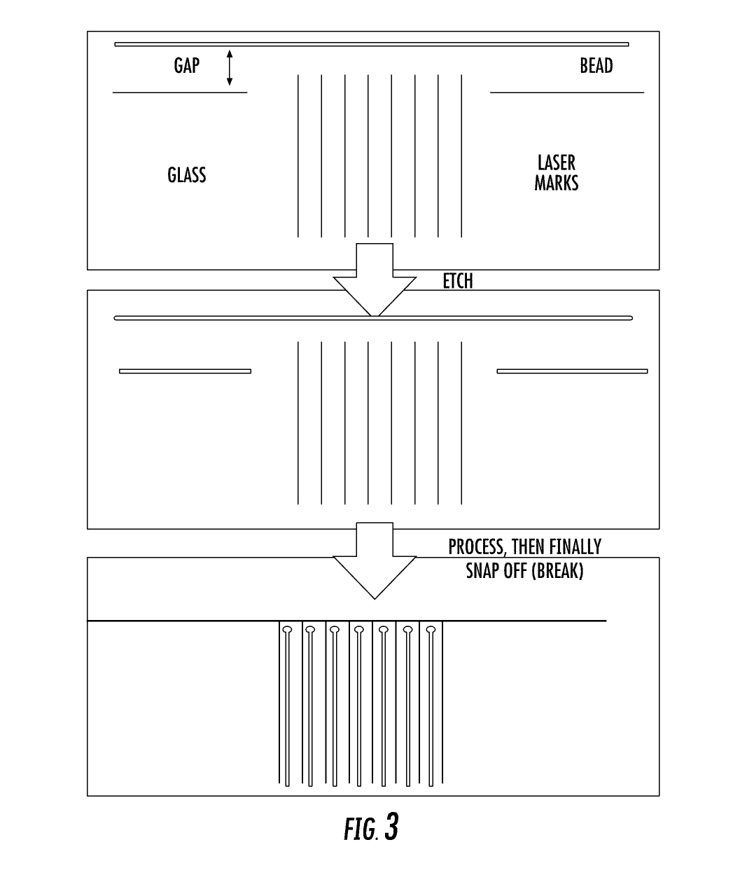

Referring generally to FIG. 3, some embodiments relate to a method of making small features in thin glass, such as those of a 25 μm test probe. Some such features include channels (e.g., fingers), such as those having a width of less than 100 μm, such as less than 50 μm, such as about 25 μm, and/or at least less than 100 nm. The channels may have a length of at least 100 μm, such as at least 500 μm, such as at least 1 mm, such as at least 2 mm, and/or no more than 2 m. At least portions of the channels may be linear. At least portions of the channels may be parallel with other channels of portions of such channels. In some embodiments, the channels extend fully through the substrate. The substrate may be particularly thin, such as less than 500 μm in thickness, such as less than 300 μm, such as less than 200 μm, such as at least 100 nm. In some such embodiments, the substrate with the channels may be stacked with another substrate without channels on top and/or on underneath, and bonded thereto to provide additional walls to the channels. In some embodiments, the substrate includes a plurality of such channels, such as at least 5. This resulting substrate could be coated with metal before laser processing to form the channels, or afterward and could be used to test circuits as a test probe card.

According to an exemplary embodiment, the substrate is formed from a glass material, such as an amorphous glass and/or a glass-ceramic have at least some crystalline content. In some such embodiments, the substrate is more specifically a glass substrate and/or includes amorphous glass, such as is mostly formed from amorphous glass. In some such embodiments, the glass comprises silica, such as is mostly formed from silica. In some such embodiments, the glass is at least 70% by weight silica, such as at least 80% by weight, such as at least 90% by weight silica. In some such embodiments, the glass of the substrate is high purity fused silica, such as at least 99% by weight fused silica, such as at least 99.99%, such as at least 99.9999%. In other embodiments, one or more layers of the substrate are such high purity fused silica. The substrate may be coated.

According to an exemplary embodiment, the substrate is a sintered sheet of high purity fused silica soot, as opposed to being cut from a boule. Formation of the substrate from the soot may allow for a continuous, in-line, roll-to-roll process for making the substrates, as taught by U.S. application Ser. No. 62/376701 filed Aug. 18, 2016, which is incorporated by reference herein in its entirety. Such silica sheets may be formed without polishing, and may be free of indicia of grinding and polishing, such as surface-level contamination and/or abrasion wear striation on the surface microstructure. The substrates may be cut by lasers, such as CO₂ lasers, and may be laser machined as disclosed herein. Applicants believe fused silica to be particularly useful due to the dielectric properties and ability to facilitate high frequency semiconductors.

A surprising finding was that fluence to fabricate the features (e.g., depressions, holes, channels) for silica manufactured from sintering soot sheets is different than fluence for forming features in silica made from boule processes. Applicants have observed the fluence to be almost double for silica from sintered soot sheets, such as up to 10.0 J/cm² for silica of about 100 μm in thickness, which may allow for sharper features to be cut. Not to be limited by the following theory, it is thought that the difference is due to processing differences in the thin sheet process over boule processes that changes the thermo-physical response to laser processing and/or scattering due to the waviness of the thin silica, which may be a fingerprint of laser sintering.

Still referring to FIG. 3, a process of making a test probe or other such device with very fine spacing between features (e.g., channels, holes, bowls) includes several steps. One step includes creating laser damage, such as in lines, on the substrate. In this step, the laser beam should be at low enough energy to not cause excessive chipping of the substrate. Additionally, the laser beam should not create cracks. A goal of this step is to make damage (e.g., line, path) that will preferentially etch. According to an exemplary embodiment, placement of this damage is strategic so that the substrate remains one piece with finger-like structures or other features securely held. For example, in some such embodiments, laser-induced damage does not fully bisect the substrate. Put another way, at least a portion of the damage terminates in and/or adjoins undamaged substrate that at least in part surrounds the damage and may limit inadvertent fracturing of the substrate. Applicants have found that keeping the substrate together as one piece helps with handling and downstream processing, such as metal coating.

The process of making a test probe or other such device may include another step of etching, such as acid etching, the substrate to enlarge the damage caused by the laser. Applicants have found that, as a side benefit, the etching may also increase strength of the edges of the substrate, such as by removing or dulling small cracks or crack nucleation sites. The etching step may be followed by a step of metallization/lithography, etc., such as coating or depositing a thin film of metal (e.g., copper, aluminum, gold) on the substrate, such as filling the etched features and/or coating surfaces surrounding the features. Another step, before usage, may be to allow the features (e.g., channels, fingers) to be free or unconnected by breaking and/or cutting off an end of the substrate so that the features extend fully to the edge of the substrate.

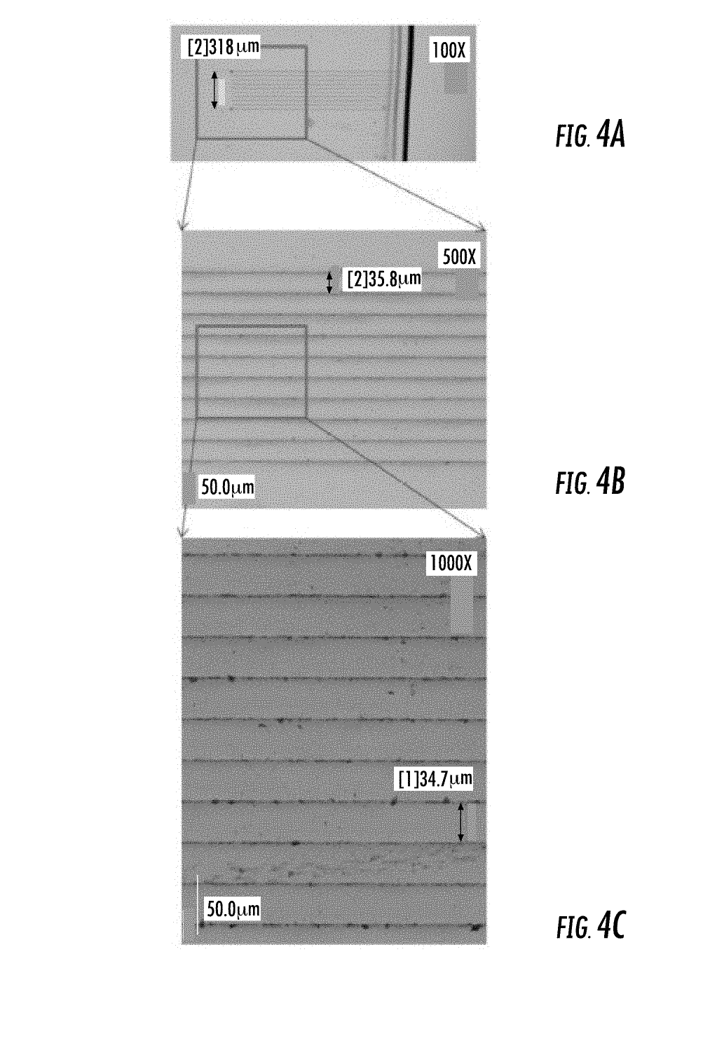

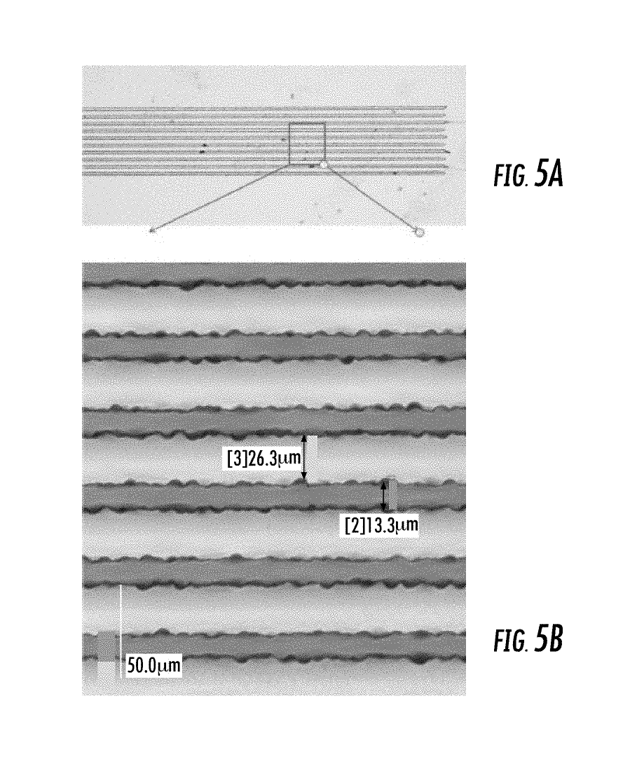

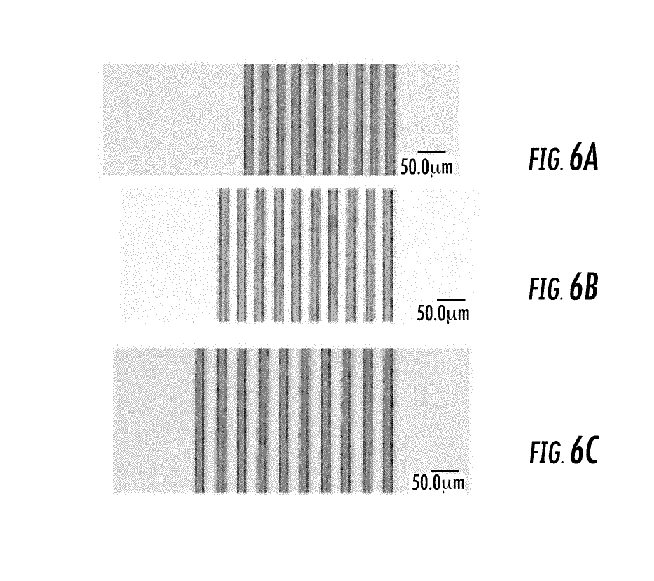

For high purity fused silica substrates, the following conditions may be used. Using optics to achieve a line focus of 0.8 mm from a 6 mm diameter input beam, the laser beam was pulsed at an energy of 400 μJ at 20 pulses per burst. Spacing between laser-damaged features (e.g., lines, spots in a line) was 2 to 4 μm. The laser damaged regions were then acid etched in a room temperature (about 21° C.), in a static bath of etchant solution 2.9M Hydrofluoric Acid (HF) and 2.4M Nitric Acid (HNO₃). The fused silica in this solution has an etch rate of about ˜0.0333 μm per min, taking 2-3 hours for etching the necessary 4 to 5 μm to separate micro-features from one another. FIGS. 4a to 4c show an example of laser damage, prior to etching, and FIGS. 5a to 5b show the features after etching, without metal coating. FIGS. 6a to 6c also show etched channels, but at different spacing between the channels.

In contemplated embodiments, creating features (e.g., channels, holes, fingers) could also be performed by an all laser ablative process, without etching. Further, different features may be combined with one another, such as channels connected to holes to form multi-layer structures, such as interposers with vias, semiconductor substrates, mirco- or even nano-fluidic devices.

While the channels of substrates shown in FIGS. 4-6 may be useful for a semiconductor test probe; in other embodiments, a nano- and micro-fluidic device is made with thin silica, such as high purity fused silica made in a flame hydrolysis process in sheets or ribbon, which requires no surface polishing before being laser machined as discussed above. The thin size of such sheets of high purity fused silica, as disclosed above, formed without need of grinding or polishing, provides an efficient solution for disposable, high purity bio testing devices.

For features, such as holes or depressions as shown in FIGS. 2a to 2g, a minimum array pitch (i.e. spacing between features) is less than 100 nm, such as less than 50 nm, such as less than 10 nm in some contemplated embodiments, and/or at least 1 nm. Depth of features, such as holes or depressions as shown in FIGS. 2a to 2g, may be 200 μm or less, such as 200 μm or less, such as 100 μm or less, and/or at least 10 nm, such as at least 100 nm. It is understood that in addition to depression and trough holes, partial depth channels are possible.

In some embodiments, the laser was a CO₂ laser operated at 9.3 μm wavelength. Laser pulse energy varied from 1 mJ to 4 mJ. Laser spot size was about 150 μm. Laser pulse duration varied from 100 to 300 μs. Laser induced nano/micro deformations could be made using single laser shots.

Advantages of the present technology include an ability to have very dense spacing of features on glass, such as silica, which may be useful for electrical probes (e.g., 25 μm spacing of channels) or other such devices, include nano- and micro-fluidic devices, semiconductor substrates and interposers, among others. Further advantages include an ability to fabricate the features reliably, such as without worrying about fingers breaking; and an ability to adjust pattern spacing, as needed. Some embodiments, such as via stacking and bonding of layers, may be formed into devices without lithography steps for the substrates. Technology disclosed herein includes an ability to “finish” the process in the field (at usage site) to reduce the chance of damage to the features, such as test probe fingers. The technology benefits from using thin glass that allows compliance without sacrificing strength of the final part.

While the above disclosure describes particular equipment and corresponding setup for purposes of describing an operational system for implementing the present technology, other setups and equipment variations may be used to implement the technology disclosed herein, including different numbers and types of lasers, actuators, motivators, optics, etc. For example, setups disclosed U.S. Pub. No. 2015/0360991, which is incorporated by reference in its entirety, may be used with technology disclosed herein.

For purposes of clarity, the term “cross-sectional dimension” refers to any linear dimension extending fully across a cross-section of the respective body or feature through a geometric centroid of the respective cross-section, such as diameter or width as disclosed above. For example, if a feature is viewed in a cross-section, such as a hypothetically cleaved surface of the feature, the cross-sectional dimension would be any distance extending fully across the cleave through a geometric centroid of the cleaved surface, which may be a range of values, such as from a minimum cross-sectional dimension to a maximum cross-sectional dimension.

For purposes of clarity, as explained in the Background, two probes come down and establish electrical contact with the battery, such as by way of terminals of the battery, and an electrical signal is measured using the multi-meter. Also, Applicants believe that if the area of wafers is constant, to get more devices per wafer, electronics as well as connections to the electronics correspondingly shrink to reduce scale of electronics. Also for clarification in the Background, speed increases in computing with reduced distances due to shorter signal travel time, but the actual signal speed may remain constant and losses in cables may be frequency dependent.

For purposes of clarity, the acronym PCBs stands for printed circuit boards.

Referring to FIG. 3, spacing between the features may be constant, such as 250 μm, 100 μm, or 25 μm or they may be customized according to the die pattern requirements. The channels may be different lengths. An individual channel can have a length of at least 100 μm, such as at least 500 μm, such as at least 1 mm, such as at least 2 mm, and/or no more than 2 m. Features may generally come from one direction (bottom) as depicted in FIG. 3 or may be arranged to come from multiple directions (top/left/right sides) to increase the probe density.

Referring to the process of making a test probe or other such device, a step as disclosed above, before usage, may be to allow the features (e.g., channels, fingers) to be free or unconnected by breaking and/or cutting off an end of the substrate so that the features extend fully to the edge of the substrate. In this way the features may be free to sag (as a cantilever) and be positioned at a height different from the mother substrate.

FIGS. 6a to 6c also show etched channels as disclosed above, at different spacing between the channels relative to other embodiments or features, illustrating, for example, the versatility and customizability of the process.

In some embodiments, the features are spaced apart from one another by a distance of less than 100 μm, such as less than 50 μm.

The construction and arrangements of the material and methods in the various exemplary embodiments, are illustrative only. Although only a few embodiments have been described in detail in this disclosure, many modifications are possible (e.g., variations in sizes, dimensions, structures, shapes, and proportions of the various elements, values of parameters, mounting arrangements, use of materials, colors, orientations) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present inventive technology.

What is claimed is:

1. A device, comprising a sheet of high purity fused silica having a thickness of less than 500 μm, wherein the sheet includes features in the sheet, wherein the features have a cross-sectional dimension of less than 50 μm and a depth of at least 100 nm, wherein the features are spaced apart from one another by a distance of less than 100 μm, and wherein the silica is free of indicia of grinding and polishing.

2. The device of claim 1, wherein the features have dulled surfaces indicative of acid etching.

3. The device of claim 2, wherein the features comprise elongate channels having a length of at least 1 mm.

4. The device of claim 3, wherein the elongate channels are generally linear.

5. The device of claim 4, wherein at least portions of the elongate channels are parallel with one another.

6. The device of claim 5, wherein the sheet is a first sheet, wherein the channels are walled by one or more additional sheets of high purity fused silica stacked with and bonded to the first sheet.

7. The device of claim 1, wherein the features comprise depressions or holes that have a cross-sectional dimension of less than 1 μm.

8. The device of claim 1, wherein the depressions or holes that have a cross-sectional dimension of less than 500 nm.

9. A test probe device, comprising a sheet of high purity fused silica having a thickness of less than 500 μm, wherein the sheet includes features in the sheet, wherein the features have a cross-sectional dimension of less than 50 μm and a depth of at least 100 nm, wherein the features are spaced apart from one another by a distance of less than 50 μm, wherein the features comprise elongate channels having a length of at least 1 mm.

10. The device of claim 9, wherein the silica is free of indicia of grinding and polishing.

11. The device of claim 10, wherein the features have dulled surfaces indicative of acid etching.

12. The device of claim 10, wherein the elongate channels are generally linear.

13. The device of claim 12, wherein at least portions of the elongate channels are parallel with one another.

14. A nano- or micro-fluidic device, comprising a sheet of high purity fused silica having a thickness of less than 500 μm, wherein the sheet includes features in the sheet, wherein the features have a cross-sectional dimension of less than 50 μm and a depth of at least 100 nm, wherein the features are spaced apart from one another by a distance of less than 50 μm.

15. The device of claim 14, wherein the silica is free of indicia of grinding and polishing.

16. The device of claim 15, wherein the features comprise depressions or holes that have a cross-sectional dimension of less than 1 μm.

17. The device of claim 16, wherein the depressions or holes that have a cross-sectional dimension of less than 500 nm.

18. The device of claim 16, wherein the features further comprise channels connecting the depressions or holes.

19. The device of claim 18, wherein the sheet is a first sheet, wherein the channels are walled by one or more additional sheets of high purity fused silica stacked with and bonded to the first sheet.

20. The device of claim 18, wherein the purity of the high purity fused silica of the first sheet and the one or more additional sheets is at least 99.99% pure silica.
